(19) United States
(12) Patent Application Publication
(10) Pub. No.: US 2011/0296082 A1
(43) Pub. Date: Dec. 1, 2011

(54) Method for Improving Service Life of Flash

(75) Inventor: Huabo Guan, Guangdong (CN)

(73) Assignee: ZTE CORPORATION, Shenzhen, Guangdong (CN)

(21) Appl. No.: 13/063,625

(22) PCT Filed: Sep. 7, 2009
(86) PCT No.: PCT/CN2009/073788

§ 371 Date: Jun. 1, 2011

(30) Foreign Application Priority Data
Sep. 12, 2008 (CN) 200810165716.1

(51) Int. Cl. G06F 12/00

(52) U.S. Cl. 711/103; 711/E12.001

(57) ABSTRACT

A method for increasing service life of flash is provided. The method comprises the following steps: reading a data {T<i,j>} from the flash, calculating and obtaining the corresponding old original data Bi according to the mapping relationship, wherein i is a natural number, j=(n−1)˜0, n is an even number; determining whether the data Bi to be written in is the same as the old original data Bi by comparison, if they are the same, it is not necessary to update the data of this byte in the flash; if the value of the data Bi to be written in is not the same as the value of the old original data Bi, checking whether it is possible to write into the flash directly; if possible, writing into the flash directly; and if it is impossible to write into the flash directly, performing the operation of erasing block.

### FIELD OF THE INVENTION

The present invention relates to data storage field, and in particular, to a method for improving service life of flash.

### BACKGROUND OF THE INVENTION

The flash memory has been widely used in the field of data storage as it is characterized by being able to store the data when the power is off. Though there is almost no limitation to the Flash in the aspect of reading data, it is quite restricted in the aspect of writing data. Generally, the flash takes 512 bytes-128 Kbytes or other size as unit to constitute one block. The writing operation is classified into two types: programming and erasing. The programming operation takes byte as unit and can change each bit in the byte from 1 into 0, or remains the original value, but it cannot change the bits which are 0 into 1. The erasing operation takes block as unit to change all bits in the block into 1. However, the Flash memory is limited in the aspect of service life, and each block usually cannot be erased over 100,000 times.

Regarding the limitation that the common writing operation cannot change the bits which are 0 into 1, the method mainly used in the present is: the data originally stored in the block is firstly read out into the RAM buffer area and is changed into new data; then the original block is erased; and then the new data is written in. The drawback of this method is: even if only one bit of the data needs to be changed from 0 into 1, the data in the whole block should be read and written, and the whole block should be erased once. Usually, the duration for reading a flash is of nanosecond level, the duration for programming the flash is of microsecond level, and the duration for erasing the flash is of millisecond level or even second level. Therefore, using the above method the operation duration is increased and the service life of the Flash is shortened.

The other method is: the data to be written into the flash is buffered into the RAM buffer area, then after a period of time, it is written into the flash collectively. By this method, it can avoid spending a lot of time in updating the contents in the flash in each time of change. However, this method still cannot overcome the limitation that the bits which are 0 cannot be changed into 1 in programming, but merely can alleviate the problem to a certain degree. Moreover, another problem is introduced, i.e. if the system is power-off during the period of buffering the data, all the data that is not written into the flash will be lost.

Regarding the limitation that the flash cannot be erased over about 100,000 times, the common method currently used is wear-leveling. If the data in a certain flash block needs to be changed, suppose the block number corresponding to the data to be changed is A, at this moment, a block B which is erased for the least times will be searched for in the whole flash; if there is data in the block B, a block C which is erased for the least times will be searched for among the free blocks, the data in the block B will be copied onto the block C and the block B will be erased to make it into a free block; then, the data in the block A will be read out into the RAM, changed into new data, and written into corresponding sector in the block B; finally, the block A is erased. In the above processes, if there is no data in the block B, the new data can be written directly into the block B. To update the data in one flash block with the wear-leveling method, however, the operations of reading block, writing into block and erasing block should be performed twice and the operations last for quite a long time.

### SUMMARY OF THE INVENTION

The technical problem to be solved by the present invention is to provide a method for improving service life of flash, which can reduce the times of erasing the flash block and improve the service life of the flash to a large extent.

According to one aspect of the present invention, a method for increasing service life of flash is provided.

The method for increasing service life of flash according to the present invention comprises the following steps:

reading a data {T<i,j>} from the flash, calculating and obtaining the corresponding old original data Bi according to a mapping relationship, wherein i is a natural number, j=(n−1)˜0, n is an even number;

determining whether the data Bi to be written in is the same as the old original data Bi by comparison, if they are the same, it is not necessary to update the data of this byte in the flash;

if the value of the data Bi to be written in is not the same as the value of the old original data Bi, checking whether it is possible to write into the flash directly;

if possible, writing into the flash directly; and if it is impossible to write into the flash directly, performing the operation of erasing block.

Further, if some bits whose values are 1 in the data {T<i,j>} can be changed into 0, and then the value of the data Bi to be written in is calculated and obtained according to the mapping relationship, then it is possible to write into the flash directly.

Further, for data in the flash block, if the times of directly writing in since the last time of erasing is less than or equal to n times, it is possible to write into the flash directly.

Further, one or more bits which are 1 in the data {T<i,j>} are changed into 0 to obtain the value of the data Bi to be written in after mapping the new {T<i,j>} value, then the direct writing into the flash is completed.

Further, the mapping relationship refers to the corresponding relationship between the original data and the bit strings in the Flash, the numerical range of the original data bits is [0, 1], the numerical range of the bit strings in the Flash is [0, 2ⁿ−1], and the mapping relationship is used to determine whether the original data bit value corresponding to each bit data in the bit strings after mapping operation is 0 or 1.

Further, when there is no data in the flash, the bits of the data to be written in are transformed into the n-bit data {T<i,j>} according to the mapping relationship to be written into the flash.

In the present invention, the bit Bi of the data to be written in is transformed into the n-bit data {T<i,j>}, the suitable bits whose values are 1 in the {T<i,j>} in the flash are updated to be 0, the Bi value to be written in is obtained after mapping, thus, it is not necessary to perform the erasing operation but the data is written into the flash directly. Therefore, the limitation to the flash in programming aspect is avoided, the speed of updating the data in the flash is accelerated, the times of erasing the flash block can be greatly reduced, and the service life of flash is improved to a large extent.

The other characteristics and advantages of the present invention will be illustrated in the following Description, and partially become obvious in the Description, or will be understood by implementing the present invention. The object and other advantages of the present invention can be realized and obtained through the structures specifically indicated in the Description, Claims and the accompanying drawings.

### BRIEF DESCRIPTION OF ACCOMPANYING DRAWINGS

The accompanying drawings provide a further understanding of the present invention, form a part of the Description, and illustrate the present invention together with the embodiments thereof without limiting the present invention, wherein:

FIG. 1 is a flow chart of the process of writing into the flash according to the embodiments in the present invention; and

FIG. 2 is a state diagram of data change in one type of flash according to the embodiments in the present invention.

### DETAILED DESCRIPTION OF EMBODIMENTS

Next, the method in the present invention will be further described in conjunction with the exemplary embodiments.

The embodiments and features thereof in the present application can be combined if they are not conflicted.

The preferred embodiments of the present invention will be described in conjunction with the accompanying drawings. It should be understood that the preferred embodiments described herein are merely to illustrate and explain the present invention without limiting the present invention.

According to the embodiments in the present invention, a method for increasing service life of flash is provided. Specifically:

the bit Bi of the data to be written in is transformed into the n-bit data {T<i,j>} to be written into the flash, wherein, i is a natural number, j=(n−1)˜0, n is selected to be an even number, the n-bit data is marked by {T<i,j>}_{n-1˜0}, or represented by the symbol {T<i,j>} hereinafter.

The transformed data corresponding to the bit Bi of the original data is:

T<i,n−1>, T<i,n−2> . . . T<i,1>, T<i,0>, represented by the symbol {T<i,j>} hereinafter. There is a one-to-multiple mapping relationship between Bi and {T<i,j>}.

When there is data in the flash, the data {T<i,j>} is read form the flash, the corresponding old original data Bi is calculated and obtained according to the mapping relationship; the data Bi to be written in and the old original data Bi are compared to determine whether they are the same, if they are the same, it is not necessary to update the data of this byte in the flash; if the value of the data Bi to be written in is not the same as the old original data Bi value, it is to check whether it is possible to write into the flash directly; if possible, it is to write into the flash directly; and if it is impossible to write into the flash directly, it is to write in after the operation of erasing block is performed.

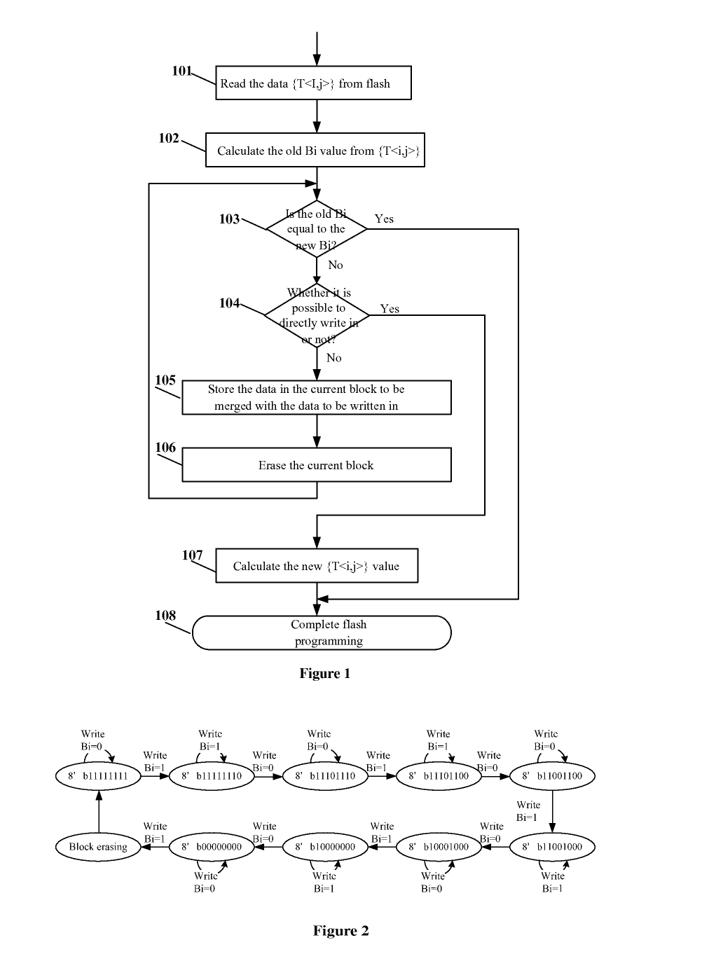

In conjunction with that shown in FIG. 1, the following steps are specifically comprised:

101. reading out {T<i,j>}_{n-1˜0} corresponding to the original data Bi from the flash;

102. calculating the current original data Bi corresponding to {T<i,j>}_{n-1˜0} according to the mapping rule, wherein the object of the calculation is to reduce the times of writing into the flash using the statistical rule;

103. comparing the old original data Bi with the new data Bi to be written in. according to the statistical rule, when the original data of one byte is written in each time, the probability of change of each bit value is only 50%. The {T<i,j>} value is read back from the flash, the Bi value (the old original data Bi value) is calculated and obtained according to the mapping relationship. If the old original data Bi value is equal to the current new Bi value (the value of the new data Bi to be written), it is not necessary to perform the operation of writing into the flash; otherwise, the process in 104 should be continued.

104. checking whether it is possible to write into the flash directly. If it is possible to change some bits whose values are 1 in the data {T<i,j>} into 0, and the value of the data Bi to be written in is calculated and obtained according to the mapping relationship, then it is possible to write into the flash directly. Possibly, it can check whether it is possible to write into the flash directly simply according to the counting of the times of writing in after erasing. The times of directly writing the data in within a certain range in the flash block since the last time of erasing is recorded. If the times of writing in is less than n times, it is possible to directly write into the flash. This method supports it is at least possible to directly write in n times after erasing block once. After that, it may be necessary to erase the block again. If it is possible to write in directly, it is transferred to 107 to perform the writing in operation; otherwise, the process in 105 should be continued;

105. before erasing the block, storing the data in the block to the buffer area to be merged with the data to be written in;

106. performing the block erasing operation, wherein after the erasing is completed, all bytes in the block are restored to be 8′b11111111;

107. according to the current {T<i,j>} value and the Bi value to be written in, determining the new {T<i,j>} value according to the mapping rule, wherein the characteristic requirements to flash programming are requested to be met, the bits that are originally 0 are not changed, and one or more bits that are originally 1 can be changed into 0; and

108. completing the programming and writing in of the bit data Bi.

When writing the data into the flash, according to the current {T<i,j>} value and the value of Bi, the new value is determined. When the new {T<i,j>} value is determined, it is requested to meet both the fixed mapping rule and the characteristic requirements to flash programming, the bits that are originally 0 are not changed, and one or more bits that are originally 1 can be changed into 0 according to the mapping relationship.

The mapping relationship in the present invention refers to the corresponding relationship between the original data bits and the bit strings {T<i,j>} in the flash. The numerical range of the original data bits is [0, 1], and the numerical range of the bit strings in the Flash is [0, 2ⁿ−1]. The mapping relationship is used to determine whether the original data bit value corresponding to each bit data in the bit strings after the mapping operation is 0 or 1. There may be various types of mapping relationship, for instance, the value of the original data bit can be determined by calculating the summary of adding all bits in the bit string. For example, all bits of the data 8′b10101010 are added to be 0, the corresponding original data bit is 0, and all bits of the data 8′b10101000 are added to be 1, the corresponding original data bit is 1. Or the bit string is equally divided into two strings (or four strings), XNOR/XOR operation is performed according to the bits, if the operation result is 4′b0000, then the corresponding original data bit will be regarded as 0, otherwise, it is 1.

Next, a quite simple mapping relationship between Bi and {T<i,j>} will be described with an example.

1) When the original data bits are transformed into n-bit data, n is selected to be an even number. In the present example, n=8. One-bit data occupies one byte in the flash after transformation, i.e. the bit string after Bi transformation is: T<i,7>, T<i,6> . . . T<i,1>, T<i,0>;

2) the bit string after transformation is divided into a first half {T<i,j>}_{j=7˜4} and a latter half {T<i,j>}_{j=3˜0}; and

3) when getting the data from the flash, the XOR operation is performed between {T<i,j>}_{j=7˜4} and {T<i,j>}_{j=3˜0} to obtain the value of Bi. If the result of each bit is 0, then the corresponding Bi value is 0, otherwise, the corresponding Bi value is 1, i.e. 4′b0000, then Bi=1′b0: otherwise Bi=1′b1.

| Times of | Current value in | | | |
|---|---|---|---|---|
| writing in | Flash | Current Bi | New Bi | New value in Flash |
| 1 | 1111-1111 | 0 | 1 | 1111-1110 |
| 2 | 1111-1110 | 1 | 0 | 1110-1110 |
| 3 | 1110-1110 | 0 | 1 | 1110-1100 |
| 4 | 1110-1100 | 1 | 0 | 1100-1100 |
| 5 | 1100-1100 | 0 | 1 | 1100-1000 |
| 6 | 1100-1000 | 1 | 0 | 1000-1000 |
| 7 | 1000-1000 | 0 | 1 | 1000-0000 |
| 8 | 1000-0000 | 1 | 0 | 0000-0000 |

| | | | |
|---|---|---|---|
| 9 | 0000-0000 | 0 | Impossible to write in directly |
| | | | Block erasing must be |
| | | | performed |

Table 1 shows the first corresponding relationship between the original data and the data in the flash.

When the data is written into the flash, firstly it is to check whether it is necessary to update the data in the flash. The data {T<i,j>}_{j=7˜0} in the flash is read, the corresponding old Bi value is calculated and obtained according to the above mapping relationship. If the new Bi value is the same as the old Bi value, it is not necessary to update the data of this byte in the flash. Otherwise, the process will be continued.

If it is necessary to update the data in the flash, firstly it is to check whether it is necessary to perform the erasing operation. If the suitable bits whose values are 1 in {T<i,j>}_{j=7˜0} can be found, they will be changed into 0. If the Bi value is the same as the new Bi value after mapping again, then it is not necessary to perform the erasing operation. For instance, the data in the flash is 11111111, the corresponding old Bi value is 0 according to the above mapping relationship, then we only need to change any one bit that is 1 in {T<i,j>}_{j=7˜0} into 0, for example, T<i,0> is changed into 0, then the data in the flash is updated to be 11111110, the new Bi value is 1 according to the above mapping relationship, and the new Bi value is written in without performing the erasing operation. Possibly, T<i,6> is changed into 0, then the data in the flash is updated to be 10111111, the new Bi value is still 1 according to the above mapping relationship, and the new Bi value also can be written in without performing the erasing operation.

In Table 1, the bit whose value is 1 is searched for according to the order of bits 0, 4, 1, 5, 2, 6, 3, 7. If it is found, this bit will be changed into 0. The state change of the byte data corresponding to one bit original data in the flash is shown in FIG. 2 during times programming operations and erasing operation. Of course, other rules meeting the requirements also can be used, such as the order of 0, 4, 5, 1, 6, 2, 3, 7, the bit whose value is 1 is searched for, and if it is found, this bit will be changed into 0. See Table 2.

| Times of | Current value in | | | |
|---|---|---|---|---|
| writing in | Flash | Current Bi | New Bi | New value in Flash |
| 1 | 1111-1111 | 0 | 1 | 1111-1110 |
| 2 | 1111-1110 | 1 | 0 | 1110-1110 |
| 3 | 1110-1110 | 0 | 1 | 1100-1110 |
| 4 | 1100-1110 | 1 | 0 | 1100-1100 |
| 5 | 1100-1100 | 0 | 1 | 1000-1100 |
| 6 | 1000-1100 | 1 | 0 | 1000-1000 |
| 7 | 1000-1000 | 0 | 1 | 1000-0000 |
| 8 | 1000-0000 | 1 | 0 | 0000-0000 |

| | | | |
|---|---|---|---|
| 9 | 0000-0000 | 0 | Impossible to write in directly |
| | | | Block erasing must be |
| | | | performed |

In the above, the order of changing the bits whose values are 1 in {T<i,j>}_{j=7˜0} into 0 is not important, as long as it is the same as the new Bi value after meeting the mapping. The times of directly writing in without performing the block erasing in the flash is merely related to n but irrelevant to the order. To sum up, with the above solutions in the present invention, the writing speed in each time of programming is greatly accelerated, the times of block erasing is reduced, and the service life of flash is improved. If the original bit data Bi is mapped as 8-bit data in the flash, then after block erasing once, it is possible to directly write 8 times without performing block erasing during that period of time. Until the 8-bit data in the flash are changed into 0, i.e. 8′b00000000, it is necessary to perform the block erasing once. If the original bit data Bi is mapped as n-bit data in the flash, it results in only performing the block erasing once when directly writing n times, and the upper limit of n can be selected according to the practical requirements and the actual condition of the chip. The relationship between the number n of bits and the service life of flash (suppose the original life service of the flash is 100,000 times) is as shown in Table 3.

| N bits | 1 | 2 | 4 | 8 | 16 | 32 | 64 |
|---|---|---|---|---|---|---|---|
| Erasable times: | 1 | 2 | 4 | 8 | 16 | 32 | 64 |
| unit: 100,000 | | | | | | | |
| times | | | | | | | |

Table 3 shows the corresponding relationship between n and the service life of flash.

Of course, when there is no data in the flash, the bits of the data to be written in can be transformed directly into n-bits data {T<i,j>} according to the mapping relationship to be written into the flash.

The invention may have some other embodiments, and the person familiar to the art, without departing from the spirit and essence of the invention, can correspondingly change and modify the invention, which should correspondingly belong to the scope of protection of the appended claims of the invention.

1. A method for increasing service life of flash, comprising the following steps:
reading a data {T<i,j>} from the flash, calculating and obtaining corresponding old original data Bi according to a mapping relationship, wherein i is a natural number, j=(n−1)˜0, and n is an even number;
determining whether a data Bi to be written in is the same as the old original data Bi by comparison, if they are the same, it is not necessary to update the data of this byte in the flash;
if a value of the data Bi to be written in is not the same as a value of the old original data Bi, checking whether it is possible to write into the flash directly;
if possible, writing into the flash directly; and if it is impossible to write into the flash directly, performing an operation of erasing block.

2. The method according to claim 1, wherein, step of checking whether it is possible to write into the flash directly is as follow: some bits whose values are 1 in the data {T<i,j>} are changed into 0, and then a value of the data Bi to be written in is calculated and obtained according to the mapping relationship, then it is possible to write into the flash directly, otherwise, it is impossible to write into the flash directly.

3. The method according to claim 1, wherein, for data in a flash block, if times of directly writing in since last time of erasing is less than or equal to n times, then it is possible to write into the flash directly.

4. The method according to claim 3, wherein, step of writing into the flash directly specifically is: one or more bits which are 1 in the data {T<i,j>} are changed into 0 to obtain the value of the data Bi to be written in after mapping a new {T<i,j>} value, then direct writing into the flash is completed.

5. The method according to claim, wherein, the mapping relationship refers to a corresponding relationship between the original data and bit strings {T<i,j>} in the Flash, a numerical range of the original data bits is [0, 1], a numerical range of the bit strings in the Flash is [0, 2n−1], and the mapping relationship is used to determine whether an original data bit value corresponding to the bit strings after mapping operation is 0 or 1.

6. The method according to claim 5, wherein, all bits in the bit strings {T<i,j>} are added to determine corresponding Bi value.

7. The method according to claim 5, wherein, the bit string is equally divided into two strings or four strings, and XNOR/XOR operation is performed according to the bits to determine corresponding Bi value.

8. The method according to claim 1, wherein, before erasing the block, the data in the block is stored into a buffer area to be merged with the data to be written in.

9. The method according to claim 1, wherein, when there is no data in the flash, bits of the data to be written in are transformed directly into n-bit data {T<i,j>} to be written into the flash according to the mapping relationship.

10. The method according to claim 2, wherein, for data in a flash block, if times of directly writing in since last time of erasing is less than or equal to n times, then it is possible to write into the flash directly.

11. The method according to claim 10, wherein, step of writing into the flash directly specifically is: one or more bits which are 1 in the data {T<i,j>} are changed into 0 to obtain the value of the data Bi to be written in after mapping a new {T<i,j>} value, then direct writing into the flash is completed.

12. The method according to claim 11, wherein, the mapping relationship refers to a corresponding relationship between the original data and bit strings {T<i,j>} in the Flash, a numerical range of the original data bits is [0, 1], a numerical range of the bit strings in the Flash is [0, 2n−1], and the mapping relationship is used to determine whether an original data bit value corresponding to the bit strings after mapping operation is 0 or 1.

13. The method according to claim 12, wherein, all bits in the bit strings {T<i,j>} are added to determine corresponding Bi value.

14. The method according to claim 12, wherein, the bit string is equally divided into two strings or four strings, and XNOR/XOR operation is performed according to the bits to determine corresponding Bi value.

15. The method according to claim 1, wherein, the mapping relationship refers to a corresponding relationship between the original data and bit strings {T<i,j>} in the Flash, a numerical range of the original data bits is [0, 1], a numerical range of the bit strings in the Flash is [0, 2n−1], and the mapping relationship is used to determine whether an original data bit value corresponding to the bit strings after mapping operation is 0 or 1.

16. The method according to claim 15, wherein, all bits in the bit strings {T<i,j>} are added to determine corresponding Bi value.

17. The method according to claim 15, wherein, the bit string is equally divided into two strings or four strings, and XNOR/XOR operation is performed according to the bits to determine corresponding Bi value.
